(19) United States
(12) Patent Application Publication
(10) Pub. No.: US 2025/0167264 A1
(43) Pub. Date: May 22, 2025

(54) AIR SUPPLY DEVICE FOR AERIAL MOBILITY VEHICLE

(71) Applicants: HYUNDAI MOTOR COMPANY, Seoul (KR); Kia Corporation, Seoul (KR)

(72) Inventors: Yoon Seok SOHN, Uiwang-si (KR); Myung Ju JUNG, Yongin-si (KR)

(73) Assignees: HYUNDAI MOTOR COMPANY, Seoul (KR); Kia Corporation, Seoul (KR)

(21) Appl. No.: 18/629,802

(22) Filed: Apr. 8, 2024

(30) Foreign Application Priority Data
Nov. 20, 2023 (KR) 10-2023-0161400

(51) Int. Cl. H01M 8/04111

(52) U.S. Cl. CPC H01M 8/04111; H01M 2250/20

(57) ABSTRACT

An air supply apparatus for an aerial mobility vehicle, which is provided with a fuel cell stack, includes an air compressor mounted in the aerial mobility vehicle and configured to compress air introduced into the aerial mobility vehicle, and an air chamber provided in the aerial mobility vehicle and connecting the air compressor and the fuel cell stack, wherein the air chamber defines a conditioning space for conditioning the air having passed through the air compressor, obtaining an advantageous effect of ensuring a stable supply of air to the fuel cell stack and improving operational stability and reliability.

### CROSS-REFERENCE TO RELATED APPLICATION

The present application claims priority to Korean Patent Application No. 10-2023-0161400 filed on Nov. 20, 2023, the entire contents of which is incorporated herein for all purposes by this reference.

### BACKGROUND OF THE PRESENT DISCLOSURE

### Field of the Present Disclosure

The present disclosure relates to an air supply apparatus for an aerial mobility vehicle, and more particularly, to an air supply apparatus for an aerial mobility vehicle, which is capable of ensuring a stable supply of air to a fuel cell stack and improving operational stability and reliability.

### Description of Related Art

A fuel cell system refers to a system that continuously produces electrical energy by a chemical reaction of continuously supplied fuel. Research and development are consistently performed on the fuel cell system as an alternative capable of solving global environmental issues.

In general, the fuel cell system may include a fuel cell stack configured to generate electricity by an oxidation-reduction reaction between hydrogen and oxygen, a fuel supply device configured to supply fuel (hydrogen) to the fuel cell stack, an air supply device configured to supply the fuel cell stack with air (oxygen) which is an oxidant required for an electrochemical reaction, and a thermal management system (TMS) configured to discharge reaction heat, which is generated from the fuel cell stack, to the outside of the system and control temperatures of the fuel cell stack.

The air supply device includes an air compressor configured to supply compressed air to the fuel cell stack. The air compressor may be configured to compress and supply air by use of a centrifugal force generated by a rotation of an impeller (rotor).

Recently, various attempts have been made to apply the fuel cell system to aerial mobility vehicles, such as aircraft and helicopters, as well as automobiles.

Meanwhile, to improve operational efficiency of the fuel cell system, it is necessary to optimize a temperature and pressure of air to be supplied to the fuel cell stack.

However, generally, there is a problem in that it is difficult to optimize the temperature and pressure of the air to be supplied to the fuel cell stack because the temperature and pressure of the air around the aerial mobility vehicle decrease as a flight altitude of the aerial mobility vehicle increases. For the present reason, there is a problem in that the operational efficiency of the fuel cell stack deteriorates.

Therefore, recently, various studies have been conducted to ensure a stable supply of air to the fuel cell stack and improve operational stability and reliability, but the study results are still insufficient. Accordingly, there is a need to develop a technology to ensure a stable supply of air to the fuel cell stack and improve operational stability and reliability.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a fuel cell system configured for ensuring a stable supply of air to a fuel cell stack and improving operational stability and reliability.

The present disclosure has been made in an effort to supply air around an aerial mobility vehicle to a fuel cell stack in a state in which the air is stabilized (optimized) to have properties suitable for an operation of the fuel cell stack.

The present disclosure has also been made in an effort to optimize properties (temperature, pressure, and flow rate) of air to be supplied to the fuel cell stack based on a flight condition of the aerial mobility vehicle.

The present disclosure has also been made in an effort to simplify a structure and improve a degree of design freedom and spatial utilization.

Among other things, the present disclosure has been made in an effort to compress air, which is to be supplied to the fuel cell stack, by use of driving power of a drive motor that generates a propulsive force for the aerial mobility vehicle.

Furthermore, the present disclosure has been made in an effort to minimize consumption of electric power, which is required to supply air to the fuel cell stack, and improve energy efficiency.

The objects to be achieved by the exemplary embodiments are not limited to the above-mentioned objects, but also include objects or effects which may be understood from the solutions or embodiments described below.

To achieve the above-mentioned objects, an exemplary embodiment of the present disclosure provides an air supply apparatus for an aerial mobility vehicle, which is provided with a fuel cell stack, the air supply apparatus including: an air compressor mounted in the aerial mobility vehicle and configured to compress air introduced into the aerial mobility vehicle; and an air chamber provided in the aerial mobility vehicle and connecting the air compressor and the fuel cell stack, wherein the air chamber defines a conditioning space for conditioning the air having passed through the air compressor.

This is to ensure a stable supply of air to the fuel cell stack and improve operational stability and reliability.

That is, to improve operational efficiency of the fuel cell system, it is necessary to optimize a temperature and pressure of air to be supplied to the fuel cell stack. However, generally, there is a problem in that it is difficult to optimize the temperature and pressure of the air to be supplied to the fuel cell stack because the temperature and pressure of the air around the aerial mobility vehicle decrease as a flight altitude of the aerial mobility vehicle increases. For the present reason, there is a problem in that the operational efficiency of the fuel cell stack deteriorates.

In contrast, in the exemplary embodiment of the present disclosure, the air around the aerial mobility vehicle passes through the air chamber and is supplied to the fuel cell stack in a state in which the air is conditioned (stabilized). Therefore, it is possible to obtain an advantageous effect of minimizing the deterioration in properties (temperature and pressure) of the air to be supplied to the fuel cell stack and improving the operational efficiency of the fuel cell stack.

Among other things, in the exemplary embodiment of the present disclosure, the air (low-temperature, low-pressure air), which is introduced into the aerial mobility vehicle at a high altitude, is not introduced immediately into the fuel cell stack but is conditioned (stabilized) by the air chamber and then supplied to the fuel cell stack so that the air has properties (e.g., temperature and pressure) suitable for the operation of the fuel cell stack. Therefore, it is possible to obtain an advantageous effect of improving the operational efficiency, stability, and reliability of the fuel cell stack.

According to the exemplary embodiment of the present disclosure, the aerial mobility vehicle may include: an aerial mobility vehicle main body; a driving fan mounted in the aerial mobility vehicle main body and configured to generate a propulsive force for the aerial mobility vehicle main body; and a drive motor provided rearward of the driving fan and connected to the driving fan to provide driving power for rotating the driving fan, and the air compressor may be provided at a downstream side of the drive motor.

As described above, in the exemplary embodiment of the present disclosure, the air introduced into the aerial mobility vehicle through the driving fan is introduced into the air compressor via the drive motor. Therefore, it is possible to ensure performance in cooling the drive motor and raise the temperature of the air to be introduced into the air compressor without using a separate heater.

That is, the temperature of the air around the aerial mobility vehicle is lowered to a low temperature (e.g., −50° C.) as the flight altitude of the aerial mobility vehicle increases. Therefore, it is necessary to raise the temperature of the air to be introduced into the air compressor to optimize the temperature of the air to be supplied to the fuel cell stack. In the exemplary embodiment of the present disclosure, the temperature of the air introduced into the aerial mobility vehicle is raised as the air passes through the drive motor so that it is possible to raise the temperature of the air to be introduced into the air compressor without using a separate heater. Furthermore, in the exemplary embodiment of the present disclosure, it is not necessary to provide a separate heater for heating the air to be introduced into the air compressor. Therefore, it is possible to obtain an advantageous effect of simplifying the structure and improving the spatial utilization and degree of design freedom.

According to the exemplary embodiment of the present disclosure, the air supply apparatus for an aerial mobility vehicle may include an air intake portion formed in the aerial mobility vehicle main body and configured to allow air to be introduced into the air intake portion from the outside thereof, and an opening/closing member mounted on the aerial mobility vehicle main body and configured to selectively open or close the air intake portion.

The opening/closing member may have various structures configured for selectively opening or closing the air intake portion.

For example, the opening/closing member may be configured to be rotatable about one end portion thereof from a first position, at which the opening/closing member closes the air intake portion, to a second position at which the opening/closing member opens the air intake portion.

As an exemplary embodiment of the present disclosure, the opening/closing member may be configured to be rectilinearly movable from a first position, at which the opening/closing member closes the air intake portion, to a second position at which the opening/closing member opens the air intake portion.

According to the exemplary embodiment of the present disclosure, the opening/closing member may be configured to open or close the air intake portion based on a flight condition of the aerial mobility vehicle.

This is based on the fact that an output of the fuel cell stack varies depending on the flight condition (e.g., takeoff, cruise, or landing) of the aerial mobility vehicle. It is possible to control a supply flow rate of the air to be supplied to the fuel cell stack based on the flight condition of the aerial mobility vehicle.

According to the exemplary embodiment of the present disclosure, the opening/closing member may be configured to close the air intake portion while the aerial mobility vehicle cruises at an altitude equal to or greater than a predetermined reference altitude, and the opening/closing member may be configured to open the air intake portion while the aerial mobility vehicle takes off or lands.

According to the exemplary embodiment of the present disclosure, the air supply apparatus for an aerial mobility vehicle may include a power transmission portion connecting the drive motor and the air compressor and configured to transmit the driving power of the drive motor to the air compressor.

As described above, in the exemplary embodiment of the present disclosure, the power transmission portion may allow the air compressor to operate by use of the driving power of the drive motor configured to generate the propulsive force for the aerial mobility vehicle. Therefore, it is not necessary to provide a separate drive device for operating the air compressor, which makes it possible to obtain an advantageous effect of simplifying the structure and improving the degree of design freedom and spatial utilization.

According to the exemplary embodiment of the present disclosure, the air supply apparatus for an aerial mobility vehicle may include a bypass line configured to selectively guide discharged air, which is discharged from the fuel cell stack, to an upstream side of the air compressor.

According to the exemplary embodiment of the present disclosure, the discharged air flows to the upstream side of the air compressor along the bypass line while the aerial mobility vehicle cruises at an altitude equal to or greater than a predetermined reference altitude.

As described above, in the exemplary embodiment of the present disclosure, the discharged air, which is discharged from the fuel cell stack and has a comparatively high temperature, flows to the upstream side of the air compressor along the bypass line while the aerial mobility vehicle cruises at an altitude equal to or greater than the predetermined reference altitude. Therefore, it is possible to more effectively raise the temperature of the air to be introduced into the air compressor without using a separate heater.

According to the exemplary embodiment of the present disclosure, the air supply apparatus for an aerial mobility vehicle may include a discharge hole provided in the bypass line configured to discharge condensate water, which is discharged from the fuel cell stack together with the discharged air, to the outside of the bypass line.

According to the exemplary embodiment of the present disclosure, the air supply apparatus for an aerial mobility vehicle may include a discharge line configured to selectively discharge the discharged air and condensate water, which are discharged from the fuel cell stack, to the outside of the aerial mobility vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view for explaining an air supply device for an aerial mobility vehicle according to an exemplary embodiment of the present disclosure.

FIG. 2 is a view for explaining an air chamber of the air supply device for an aerial mobility vehicle according to the exemplary embodiment of the present disclosure.

FIG. 3 is a view for explaining an output of a fuel cell stack, which varies depending on a flight condition of an aerial mobility vehicle main body, in the air supply device for an aerial mobility vehicle according to the exemplary embodiment of the present disclosure.

FIG. 4 and FIG. 5 are views for explaining a modified example of an opening/closing member of the air supply device for an aerial mobility vehicle according to the exemplary embodiment of the present disclosure.

FIG. 6 is a view for explaining a bypass line of the air supply device for an aerial mobility vehicle according to the exemplary embodiment of the present disclosure.

FIG. 7 is a view for explaining a discharge line of the air supply device for an aerial mobility vehicle according to the exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

However, the technical spirit of the present disclosure is not limited to various exemplary embodiments described herein but may be implemented in various different forms. One or more of the constituent elements in the exemplary embodiments of the present disclosure may be selectively combined and substituted for use within the scope of the technical spirit of the present disclosure.

Furthermore, unless otherwise specifically and explicitly defined and stated, the terms (including technical and scientific terms) used in the exemplary embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

Furthermore, the terms used in the exemplary embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that may be made by combining A, B, and C.

Furthermore, the terms such as first, second, A, B, (a), and (b) may be used to describe constituent elements of the exemplary embodiments of the present disclosure.

These terms are used only for discriminating one constituent element from another constituent element, and the nature, the sequences, or the orders of the constituent elements are not limited by the terms.

Furthermore, when one constituent element is described as being ‘connected’, ‘coupled’, or ‘attached’ to another constituent element, one constituent element may be connected, coupled, or attached directly to another constituent element or connected, coupled, or attached to another constituent element through yet another constituent element interposed therebetween.

Furthermore, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

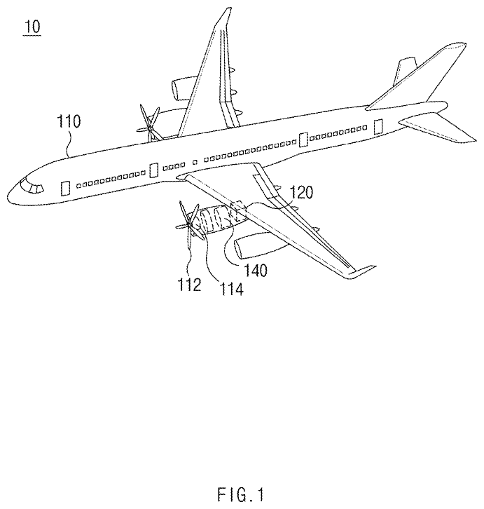

With reference to FIGS. 1 to 7, an air supply device for an aerial mobility vehicle, which is provided with a fuel cell stack 120 according to an exemplary embodiment of the present disclosure, includes an air compressor 130 provided in an aerial mobility vehicle 10 and configured to compress air to be introduced into the aerial mobility vehicle 10, and an air chamber 140 provided in the aerial mobility vehicle 10 and configured to connect the air compressor 130 and the fuel cell stack 120, the air chamber 140 configured to define a conditioning space 141 for conditioning the air having passed through the air compressor 130.

The air supply device for an aerial mobility vehicle according to the exemplary embodiment of the present disclosure may be applied to various aerial mobility vehicles 10 in accordance with required conditions and design specifications. The present disclosure is not restricted or limited by the type and properties of the aerial mobility vehicle 10 to which the air supply device for an aerial mobility vehicle is applied.

Hereinafter, an example will be described in which the air supply device for an aerial mobility vehicle according to an exemplary embodiment of the present disclosure is applied to an airplane.

The aerial mobility vehicle 10 may have various structures in accordance with required conditions and design specifications. The present disclosure is not restricted or limited by the structure and shape of the aerial mobility vehicle 10.

According to the exemplary embodiment of the present disclosure, the aerial mobility vehicle 10 may include an aerial mobility vehicle main body 110 including a fuselage and wings, driving fans 112 provided on the aerial mobility vehicle main body 110 (e.g., wings) and configured to generate a propulsive force for the aerial mobility vehicle main body 110, and drive motors 114 provided rearward of the driving fans 112 and configured to provide driving power for rotating the driving fans 112.

For reference, the fuel cell stack 120 refers to a kind of power generation device that generates electrical energy through a chemical reaction of fuel (e.g., hydrogen). The fuel cell stacks 120 are provided in the aerial mobility vehicle.

For example, the fuel cell stack 120 may be configured by stacking several tens or hundreds of fuel cells (unit cells) in series.

The fuel cell may have various structures configured for producing electricity by an oxidation-reduction reaction between fuel (e.g., hydrogen) and an oxidant (e.g., air).

For example, the fuel cell may include: a membrane electrode assembly (MEA) including catalyst electrode layers in which electrochemical reactions occur and which are attached to two opposite sides of an electrolyte membrane through which hydrogen ions move; a gas diffusion layer (GDL) configured to uniformly distribute reactant gases and transfer generated electrical energy; a gasket and a fastener configured to maintain leakproof sealability for the reactant gases and a coolant and maintain an appropriate fastening pressure; and a separator (bipolar plate) configured to move the reactant gases and the coolant.

In the fuel cell, hydrogen, which is fuel, and air (oxygen), which is an oxidant, are supplied to an anode and a cathode of the membrane electrode assembly, respectively, through flow paths in the separator so that the hydrogen is supplied to the anode, and the air is supplied to the cathode.

The hydrogen supplied to the anode is decomposed into hydrogen ions (protons) and electrons by catalysts in the electrode layers provided at two opposite sides of the electrolyte membrane. Only the hydrogen ions are selectively transmitted to the cathode through the electrolyte membrane, which is a cation exchange membrane, and at the same time, the electrons are transmitted to the cathode through the gas diffusion layer and the separator which are conductors.

At the cathode, the hydrogen ions supplied through the electrolyte membrane and the electrons transmitted through the separator meet oxygen in the air supplied to the cathode by an air supply device, generating a reaction of producing water. As a result of the movement of the hydrogen ions, the electrons flow through external conductive wires, and the electric current is generated as a result of the flow of the electrons.

The air compressor 130 is configured to compress the air introduced into the aerial mobility vehicle and supply the compressed air to the fuel cell stack 120.

A typical compressor configured for compressing air may be used as the air compressor 130. The present disclosure is not restricted or limited by the type and structure of the air compressor 130.

For example, the air compressor 130 may include a compressor housing 132, and a compressor fan 134 rotatably provided in the compressor housing 132.

The air chamber 140 is provided in the aerial mobility vehicle and connects the air compressor 130 and the fuel cell stack 120. The air chamber 140 defines the conditioning space 141 for conditioning the air having passed through the air compressor 130.

In the instant case, the conditioning space 141 may be defined as a space (e.g., a space including a cross-sectional area greater than inlet and outlet ports of the air chamber) in which the air may temporarily stay. The air, which has passed through the air compressor 130, may pass through the conditioning space 141 of the air chamber 140 and then be supplied to the fuel cell stack 120.

The air chamber 140 may have various structures configured for providing the conditioning space 141. The present disclosure is not restricted or limited by the structure and shape of the air chamber 140.

For example, the air chamber 140 may be provided in a form of an approximately quadrangular box. An inlet port 142, to which an outlet of the air compressor 130 is connected, may be provided at one end portion of the air chamber 140, and an outlet port 144, to which an inlet of the fuel cell stack 120 is connected, may be provided at the other end portion of the air chamber 140. According to another exemplary embodiment of the present disclosure, the air chamber may include a circular or other shapes.

As described above, in the exemplary embodiment of the present disclosure, the air around the aerial mobility vehicle passes through the air chamber 140 and is supplied to the fuel cell stack 120 in a state in which the air is conditioned (stabilized). Therefore, it is possible to obtain an advantageous effect of minimizing the deterioration in properties (temperature and pressure) of the air to be supplied to the fuel cell stack 120 and improving the operational efficiency of the fuel cell stack 120.

In the exemplary embodiment of the present disclosure, the air (low-temperature, low-pressure air), which is introduced into the aerial mobility vehicle at a high altitude, is not introduced immediately into the fuel cell stack 120 but is conditioned (stabilized) by the air chamber 140 and then supplied to the fuel cell stack 120 so that the air has properties (e.g., temperature and pressure) suitable for the operation of the fuel cell stack 120. Therefore, it is possible to obtain an advantageous effect of maintaining a stable supply flow rate of the air to be supplied to the fuel cell stack 120 and improving the operational efficiency, stability, and reliability of the fuel cell stack 120.

Meanwhile, the air compressor 130 may be mounted at various positions in the aerial mobility vehicle in accordance with required conditions and design specifications. The present disclosure is not restricted or limited by the position at which the air compressor 130 is mounted.

According to the exemplary embodiment of the present disclosure, the air compressor 130 may be provided at a downstream side of the drive motor 114, and the air introduced through the driving fan 112 may be introduced into the air compressor 130 via the drive motor 114.

As described above, in the exemplary embodiment of the present disclosure, the air introduced into the aerial mobility vehicle through the driving fan 112 is introduced into the air compressor 130 via the drive motor 114. Therefore, it is possible to ensure performance in cooling the drive motor 114 and raise the temperature of the air to be introduced into the air compressor 130 without using a separate heater.

That is, the temperature of the air around the aerial mobility vehicle is lowered to a low temperature (e.g., −50° C.) as the flight altitude of the aerial mobility vehicle increases. Therefore, it is necessary to raise the temperature of the air to be introduced into the air compressor 130 to optimize the temperature of the air to be supplied to the fuel cell stack 120. In the exemplary embodiment of the present disclosure, the temperature of the air introduced into the aerial mobility vehicle is raised as the air passes through the drive motor 114 so that it is possible to raise the temperature of the air to be introduced into the air compressor 130 without using a separate heater. Furthermore, in the exemplary embodiment of the present disclosure, it is not necessary to provide a separate heater for heating the air to be introduced into the air compressor 130. Therefore, it is possible to obtain an advantageous effect of simplifying the structure and improving the spatial utilization and degree of design freedom.

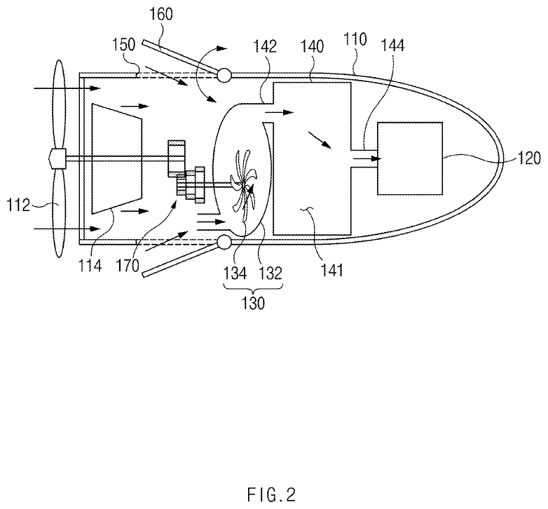

With reference to FIGS. 2 and 4 to 5, according to the exemplary embodiment of the present disclosure, the air supply device for an aerial mobility vehicle may include an air intake portion 150 provided in the aerial mobility vehicle main body 110 and configured to allow air to be introduced into the air intake portion 150 from the outside thereof, and an opening/closing member 160 configured to selectively open or close the air intake portion 150.

The air intake portion 150 may have various structures into which air may be introduced from the outside thereof. The present disclosure is not restricted or limited by the structure and shape of the air intake portion 150. For example, the air intake portion 150 may be provided in a form of an approximately quadrangular hole.

The air intake portion 150 may be provided at various positions in the aerial mobility vehicle main body 110 in accordance with required conditions and design specifications. The present disclosure is not restricted or limited by the position of the air intake portion 150.

According to the exemplary embodiment of the present disclosure, the air intake portion 150 may be provided between the drive motor 114 and the air compressor 130, and the air introduced into the air intake portion 150 may be immediately introduced into the air compressor 130 without passing through the driving fan 112 and the drive motor 114.

The opening/closing member 160 may have various structures configured for selectively opening or closing the air intake portion 150. The present disclosure is not restricted or limited by the structure of the opening/closing member 160 and the method of opening or closing the opening/closing member 160.

In the instant case, the configuration in which the opening/closing member 160 opens or closes the air intake portion 150 is defined as including both a configuration in which a flow of air to be introduced into the aerial mobility vehicle main body 110 through the air intake portion 150 is turned on or off and a configuration in which a flow rate of the air is adjusted.

For example, the flow rate of the air to be introduced into the air compressor 130 may be adjusted by changing a cross-sectional area of the air intake portion 150 (an air passing area of the air intake part).

For example, with reference to FIG. 2, the opening/closing member 160 may be configured to rotate about one end portion thereof from a first position, at which the opening/closing member 160 closes the air intake portion 150, to a second position at which the opening/closing member 160 opens the air intake portion 150.

That is, the opening/closing member 160 may be configured to selectively open or close the air intake portion 150 while rotating about one end portion (a right end portion based on FIG. 2) thereof in a hinged manner.

The air intake portion 150 may be closed in the state in which the opening/closing member 160 is positioned at the first position thereof. In the state in which the opening/closing member 160 is moved (rotated or rectilinearly moved) to the second position, the air intake portion 150 may be opened, and outside air may be introduced through the air intake portion 150.

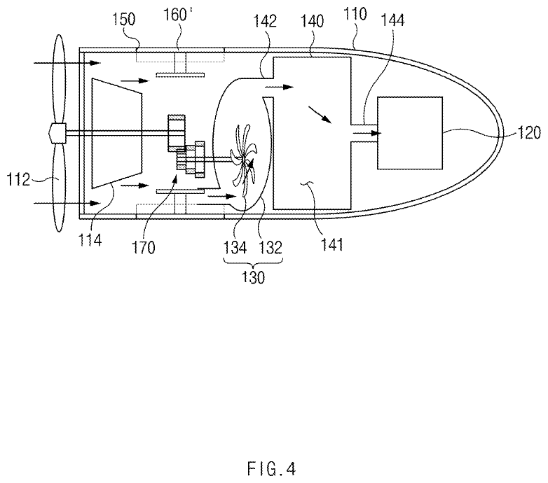

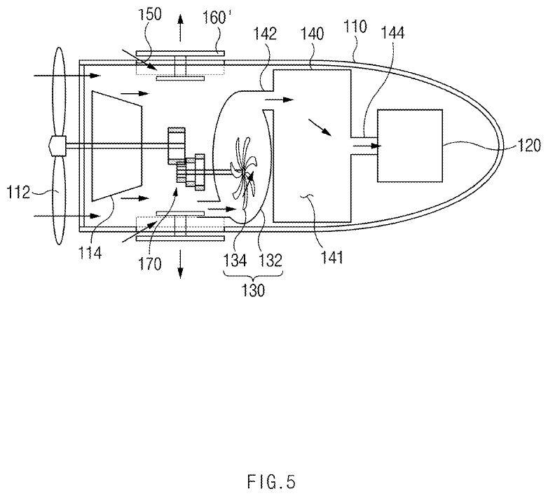

As an exemplary embodiment of the present disclosure, with reference to FIG. 4 and FIG. 5, an opening/closing member 160′ may be configured to be rectilinearly movable from the first position, at which the opening/closing member 160′ closes the air intake portion 150, to the second position at which the opening/closing member 160′ opens the air intake portion 150.

For example, the opening/closing member 160′ may be configured to be rectilinearly movable from the first position to the second position in a direction toward or away from the aerial mobility vehicle main body 110 (e.g., in an upward/downward direction based on FIG. 4).

According to another exemplary embodiment of the present disclosure, the opening/closing member may be configured to rectilinearly move from the first position to the second position in a longitudinal direction of the aerial mobility vehicle main body in a sliding manner.

According to the exemplary embodiment of the present disclosure, the opening/closing member 160 may be configured to open or close the air intake portion 150 based on a flight condition of the aerial mobility vehicle.

This is based on the fact that an output of the fuel cell stack 120 varies depending on the flight condition (e.g., takeoff, cruise, or landing) of the aerial mobility vehicle. It is possible to control a supply flow rate of the air to be supplied to the fuel cell stack 120 based on the flight condition of the aerial mobility vehicle.

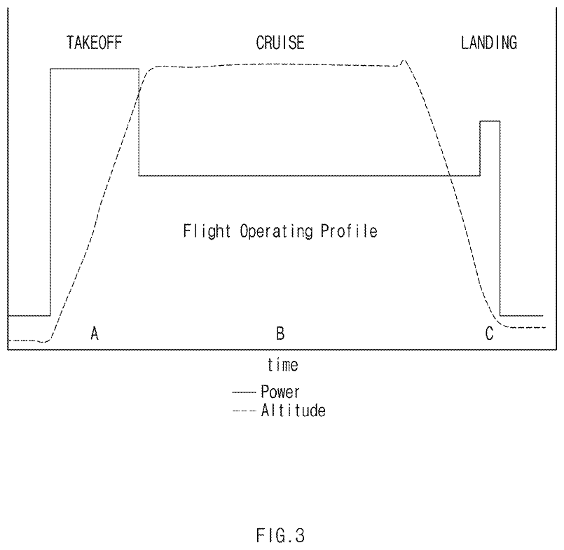

That is, with reference to FIG. 3, during the takeoff and landing of the aerial mobility vehicle, the fuel cell stack 120 operates under a high-output operation condition, and thus, air needs to be supplied at a high flow rate to the fuel cell stack 120. During the cruise (constant-speed flight) of the aerial mobility vehicle, the fuel cell stack 120 operates under a constant-output operation condition, and thus, air needs to be supplied at a relatively low flow rate to the fuel cell stack 120.

In an exemplary embodiment of the present disclosure, the opening/closing member 160 or 160′ is connected to an actuator to operate the opening/closing member 160 or 160′. In addition, the actuator is connected to a control unit to control the operation of the opening/closing member 160 or 160′.

According to the exemplary embodiment of the present disclosure, the opening/closing member 160 may configured to close the air intake portion 150 (see FIG. 4) while the aerial mobility vehicle cruises at an altitude equal to or greater than a predetermined reference altitude (e.g., under a high-altitude environment at −50° C.), which is determined by the controller. The opening/closing member 160 may configured to open the air intake portion 150 (see FIGS. 2 and 5) while the aerial mobility vehicle takes off or lands (e.g., under a low-altitude environment at 5 to 35° C.).

According to the exemplary embodiment of the present disclosure, the air supply device for an aerial mobility vehicle may include a power transmission portion 170 configured to transmit the driving power of the drive motor 114 to the air compressor 130.

The power transmission portion 170 is configured to allow the air compressor 130 to be operated by the driving power of the drive motor 114.

Various power transmission portions 170 configured for transmitting the driving power of the drive motor 114 to the air compressor 130 (e.g., the compressor fan) may be used as the power transmission portion 170. The present disclosure is not restricted or limited by the type and structure of the power transmission portion 170.

For example, a typical gearbox, which is configured by combining a plurality of gears, may be used as the power transmission portion 170.

As described above, in the exemplary embodiment of the present disclosure, the power transmission portion 170 may allow the air compressor 130 to operate (compress the air to be supplied to the fuel cell stack) by use of the driving power of the drive motor 114 to generate the propulsive force for the aerial mobility vehicle. Therefore, it is not necessary to provide a separate drive device for operating the air compressor 130, which makes it possible to obtain an advantageous effect of simplifying the structure and improving the degree of design freedom and spatial utilization.

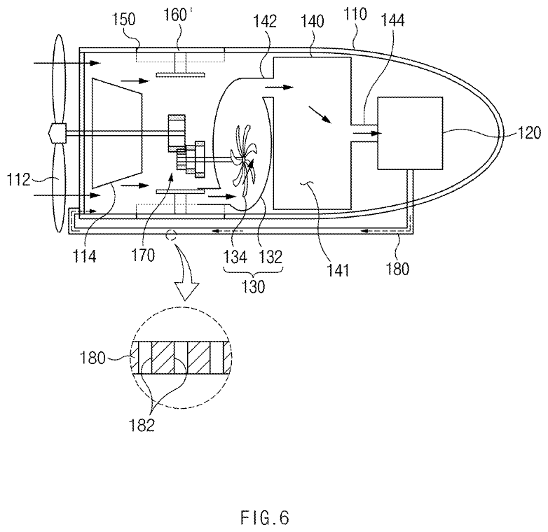

With reference to FIG. 6, according to the exemplary embodiment of the present disclosure, the air supply device for an aerial mobility vehicle may include a bypass line 180 configured to selectively guide discharged air, which is discharged from the fuel cell stack 120, to an upstream side of the air compressor 130 (an upstream side of the inlet of the air compressor).

For example, one end portion of the bypass line 180 may be connected to an outlet of the fuel cell stack 120, and the other end portion of the bypass line 180 may be disposed at an upstream side of the drive motor 114 and connected to the aerial mobility vehicle main body 110.

The bypass line 180 may have various structures configured for guiding the discharged air, which is discharged from the fuel cell stack 120, to the upstream side of the air compressor 130. The present disclosure is not restricted or limited by the structure and shape of the bypass line 180.

For example, the bypass line 180 may include an approximately “U” shape.

A time point at which the discharged air, which is discharged from the fuel cell stack 120, is supplied to the upstream side of the air compressor 130 may be variously changed in accordance with required conditions and design specifications.

The discharged air may flow to the upstream side of the air compressor 130 along the bypass line 180 while the aerial mobility vehicle cruises at an altitude equal to or greater than the predetermined reference altitude.

The bypass line 180 may be opened or closed by various valves in accordance with required conditions and design specifications. The present disclosure is not restricted or limited by the type and properties of the valve configured to open or close the bypass line 180. For example, the bypass line 180 may be opened or closed by a typical electronic valve such as a solenoid valve connected to a control unit.

For example, the control unit may open the bypass line 180 by controlling the electronic valve while the aerial mobility vehicle cruises at an altitude equal to or higher than the preset reference altitude.

As described above, in the exemplary embodiment of the present disclosure, the discharged air, which is discharged from the fuel cell stack 120 and has a comparatively high temperature (e.g., 60 to 70° C.), flows to the upstream side of the air compressor 130 along the bypass line 180 while the aerial mobility vehicle cruises at an altitude equal to or greater than the predetermined reference altitude (e.g., under a high-altitude environment at −50° C.). Therefore, it is possible to more effectively raise the temperature of the air to be introduced into the air compressor 130 without using a separate heater.

According to the exemplary embodiment of the present disclosure, the air supply device for an aerial mobility vehicle may include discharge holes 182 formed in the bypass line 180 to discharge condensate water, which is discharged from the fuel cell stack 120 together with the discharged air, to the outside of the bypass line 180.

The discharge hole 182 may have various structures configured for discharging the condensate water, which moves along the bypass line 180, to the outside of the bypass line 180. The present disclosure is not restricted or limited by the number of discharge holes 182 and the structure of the discharge hole 182.

For example, the discharge hole 182 may be provided in a form of an approximately circular hole. The discharge holes 182 may be provided as a plurality of discharge holes 182 spaced from one another in a longitudinal direction of the bypass line 180.

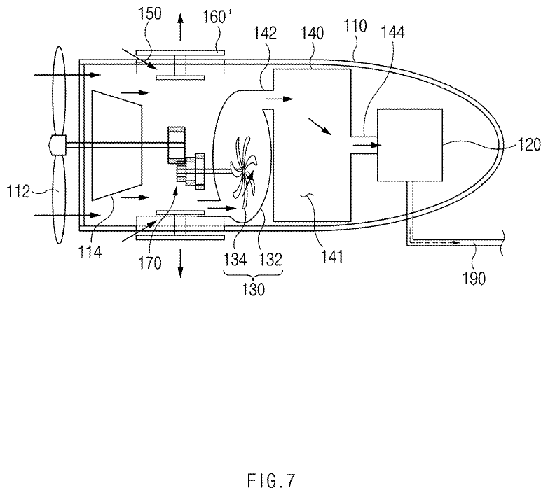

With reference to FIG. 7, according to the exemplary embodiment of the present disclosure, the air supply device for an aerial mobility vehicle may include a discharge line 190 configured to selectively discharge the discharged air and condensate water, which are discharged from the fuel cell stack 120, to the outside of the aerial mobility vehicle.

For example, one end portion of the discharge line 190 may be connected to the outlet of the fuel cell stack 120, and the other end portion of the discharge line 190 may be externally exposed of the aerial mobility vehicle main body 110.

A time point at which the discharged air and condensate water, which are discharged from the fuel cell stack 120, are discharged along the discharge line 190 may be variously changed in accordance with required conditions and design specifications.

The discharged air and condensate water may be discharged along the discharge line 190 while the aerial mobility vehicle takes off and lands.

The discharge line 190 may be opened or closed by various valves in accordance with required conditions and design specifications. The present disclosure is not restricted or limited by the type and properties of the valve configured to open or close the discharge line 190. For example, the discharge line 190 may be opened or closed by a typical electronic valve such as a solenoid valve connected to a control unit.

For example, the control unit may open the discharge line 190 by controlling the electronic valve while the aerial mobility vehicle takes off and lands.

According to the exemplary embodiment of the present disclosure described above, it is possible to obtain an advantageous effect of ensuring a stable supply of air to the fuel cell stack and improving the operational stability and reliability.

According to the exemplary embodiment of the present disclosure, it is possible to obtain an advantageous effect of supplying air around the aerial mobility vehicle to the fuel cell stack in the state in which the air is stabilized (optimized) to have properties suitable for the operation of the fuel cell stack.

Furthermore, according to the exemplary embodiment of the present disclosure, it is possible to obtain an advantageous effect of optimizing the properties (e.g., temperature, pressure, and flow rate) of the air to be supplied to the fuel cell stack based on the flight condition of the aerial mobility vehicle.

Furthermore, according to the exemplary embodiment of the present disclosure, it is possible to obtain an advantageous effect of simplifying the structure and improving the degree of freedom of design and spatial utilization.

Among other things, according to the exemplary embodiment of the present disclosure, it is possible to compress the air, which is to be supplied to the fuel cell stack, by use of the driving power of the drive motor configured to generate the propulsive force for the aerial mobility vehicle.

Furthermore, according to the exemplary embodiment of the present disclosure, it is possible to obtain an advantageous effect of minimizing the consumption of electric power, which is required to supply air to the fuel cell stack, and improving energy efficiency.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An air supply apparatus for an aerial mobility vehicle, which includes a fuel cell stack, the air supply apparatus comprising:
an air compressor mounted in the aerial mobility vehicle and configured to compress air introduced into the aerial mobility vehicle; and
an air chamber provided in the aerial mobility vehicle and connecting the air compressor and the fuel cell stack, wherein the air chamber defines a conditioning space for conditioning the air having passed through the air compressor.

2. The air supply apparatus of claim 1,
wherein the aerial mobility vehicle includes:
an aerial mobility vehicle main body;
a driving fan mounted in the aerial mobility vehicle main body and configured to generate a propulsive force for the aerial mobility vehicle main body; and
a drive motor provided rearward of the driving fan and connected to the driving fan to provide driving power for rotating the driving fan, and wherein the air compressor is provided at a downstream side of the drive motor.

3. The air supply apparatus of claim 2, including:
an air intake portion formed in the aerial mobility vehicle main body and configured to allow air to be introduced from the outside thereof into the air compressor; and
an opening/closing member mounted on the aerial mobility vehicle main body and configured to selectively open or close the air intake portion.

4. The air supply apparatus of claim 3, wherein the opening/closing member is configured to open or close the air intake portion based on a flight condition of the aerial mobility vehicle.

5. The air supply apparatus of claim 4, wherein the opening/closing member is configured to close the air intake portion while the aerial mobility vehicle cruises at an altitude equal to or greater than a predetermined reference altitude, and the opening/closing member is configured to open the air intake portion while the aerial mobility vehicle takes off or lands.

6. The air supply apparatus of claim 3, wherein the opening/closing member is configured to be rotatable about one end portion thereof between a first position, at which the opening/closing member closes the air intake portion, and a second position at which the opening/closing member opens the air intake portion.

7. The air supply apparatus of claim 3, wherein the opening/closing member is configured to be rectilinearly movable between a first position, at which the opening/closing member closes the air intake portion, and a second position at which the opening/closing member opens the air intake portion.

8. The air supply apparatus of claim 2, including:
a power transmission portion connecting the drive motor and the air compressor and configured to transmit the driving power of the drive motor to the air compressor.

9. The air supply apparatus of claim 1, including:
a bypass line fiducially connecting the fuel cell stack and an upstream side of the air compressor and guiding discharged air, which is discharged from the fuel cell stack, to the upstream side of the air compressor.

10. The air supply apparatus of claim 9, including:
a discharge hole provided in the bypass line and configured to discharge condensate water, which is discharged from the fuel cell stack together with the discharged air, to an outside of the bypass line.

11. The air supply apparatus of claim 1, including:
a bypass line connecting the fuel cell stack and an upstream side of the air compressor and selectively guiding discharged air, which is discharged from the fuel cell stack, to the upstream side of the air compressor.

12. The air supply apparatus of claim 11, wherein the discharged air flows to the upstream side of the air compressor along the bypass line while the aerial mobility vehicle cruises at an altitude equal to or greater than a predetermined reference altitude.

13. The air supply apparatus of claim 11, including:
a discharge hole provided in the bypass line and configured to discharge condensate water, which is discharged from the fuel cell stack together with the discharged air, to an outside of the bypass line.

14. The air supply apparatus of claim 1, including:
a discharge line directly connecting the fuel cell stack and an outside of the aerial mobility vehicle and discharging discharged air and condensate water, which are discharged from the fuel cell stack, to the outside of the aerial mobility vehicle.

15. The air supply apparatus of claim 1, including:
a discharge line connecting the fuel cell stack and an outside of the aerial mobility vehicle and selectively discharging discharged air and condensate water, which are discharged from the fuel cell stack, to the outside of the aerial mobility vehicle.

16. The air supply apparatus of claim 15, wherein the discharged air and the condensate water are discharged along the discharge line while the aerial mobility vehicle takes off and lands.
